(19) United States
(12) Patent Application Publication
(10) Pub. No.: US 2017/0142002 A1
(43) Pub. Date: May 18, 2017

(54) COMMUNICATION DEVICE AND COMMUNICATION SYSTEM

(71) Applicant: FUJITSU LIMITED, Kawasaki-shi (JP)

(72) Inventors: Masaaki SAITO, Kawasaki (JP); Kanta YAMAMOTO, Kokubunji (JP); AKIHIRO HATA, Kawasaki (JP)

(73) Assignee: FUJITSU LIMITED, Kawasaki-shi (JP)

(21) Appl. No.: 15/298,614

(22) Filed: Oct. 20, 2016

(30) Foreign Application Priority Data
Nov. 16, 2015 (JP) 2015-224224

(51) Int. Cl. H04L 12/709; H04L 12/26

(52) U.S. Cl. CPC H04L 45/245; H04L 43/10; H04L 43/0811

(57) ABSTRACT

A communication device that relays a communication between a certain communication device and a network, the communication device including a transfer processing circuit configured to receive a signal from the network through a further communication device and transfer the signal to the certain communication device when a failure occurs in a line between the further communication device and the certain communication device; and a transmission and reception circuit configured to receive, from the further communication device, a monitoring packet used to monitor a communication path between the further communication device and the network and transmit a response packet for the monitoring packet to the further communication device.

### CROSS-REFERENCE TO RELATED APPLICATION

This application is based upon and claims the benefit of priority of the prior Japanese Patent Application No. 2015-224224, filed on Nov. 16, 2015, the entire contents of which are incorporated herein by reference.

### FIELD

The embodiments discussed herein are related to a communication device and a communication system.

### BACKGROUND

As a technology by which a plurality of links each of which connects communication devices is bound and used as a single logical link, link aggregation (LAG) based on a link aggregation control protocol (LACP) is known. In the LAG, redundancy of the plurality of links may be achieved, and even when a failure occurs in an active link, the communication is allowed to be continued through a standby link. The LAG is defined, for example, in the Institute of Electrical and Electronics Engineers, Inc. (IEEE) 802.3ad.

In addition, as a technology by which LAG is achieved so as to extend over links of a plurality of communication devices coupled to a single communication device, a multi-chassis (MC)-LAG is known (for example, see Japanese Laid-open Patent Publication No. 2014-096656). In the MC-LAG, the plurality of communication devices is treated as a single device, when viewed from the single communication device, by performing transmission and reception of distributed relay control protocol (DRCP) packets to and from each other.

In addition, in the MC-LAG, redundancy of the plurality of communication devices is achieved, and even when a failure occurs in a link of the active communication device, the communication is allowed to be continued by using a link of a standby communication device. The MAC-LAG is defined, for example, in the Institute of Electrical and Electronics Engineers, Inc. (IEEE) 802.1ax.

In addition, as a termination point of a function of operations, administrations and maintenance (OAM) in a communication device, a maintenance end point (MEP) (for example, see Japanese Laid-open Patent Publication No. 2012-205286) is known. A communication device may monitor the state of a communication path between communication devices by performing transmission and reception of continuity check messages (CCMs) used to check the connectivity between MEPs. The MEP is defined, for example, in International Telecommunication Union Telecommunication Standardization Sector (ITU-T) Recommendation Y.1731.

In the MC-LAG, when a failure occurs in a link, a communication path is switched, but the MEP in the communication device remains to be set on the communication path before switching. Therefore, in the communication device, there is a problem that an alarm caused due to non-reception of a CCM (for example, loss of continuity (LOC)) is detected by mistake, so that the state of the communication path after switching is not monitored.

Therefore, the technology discussed herein is made by considering the above-described problem, and an object of the technology discussed herein is to provide a communication device and a communication system that are allowed to monitor the state of a communication path even when a failure has occurred.

### SUMMARY

According to an aspect of the embodiments, a communication device that relays a communication between a certain communication device and a network, the communication device including a transfer processing circuit configured to receive a signal from the network through a further communication device and transfer the signal to the certain communication device when a failure occurs in a line between the further communication device and the certain communication device; and a transmission and reception circuit configured to receive, from the further communication device, a monitoring packet used to monitor a communication path between the further communication device and the network and transmit a response packet for the monitoring packet to the further communication device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of a network configuration;

FIG. 2 is a configuration diagram illustrating a communication system in a comparative example;

FIG. 3 is a diagram illustrating a switching operation of a communication path of the communication system in the comparative example;

FIG. 4 is a configuration diagram illustrating a communication system according to an embodiment;

FIG. 5 is a diagram illustrating an operation before switching in a communication path of the communication system according to the embodiment;

FIG. 6 is a diagram illustrating an operation after switching in the communication path of the communication system according to the embodiment;

FIG. 7 is a sequence diagram illustrating an operation of the communication system according to the embodiment;

FIG. 8 is a configuration diagram illustrating an example of a DRCP packet;

FIG. 9 is a configuration diagram illustrating a further example of a control packet related to switching of a MEP; and

FIG. 10 is a diagram illustrating an example of a switching operation of a MEP instance group.

### DESCRIPTION OF EMBODIMENTS

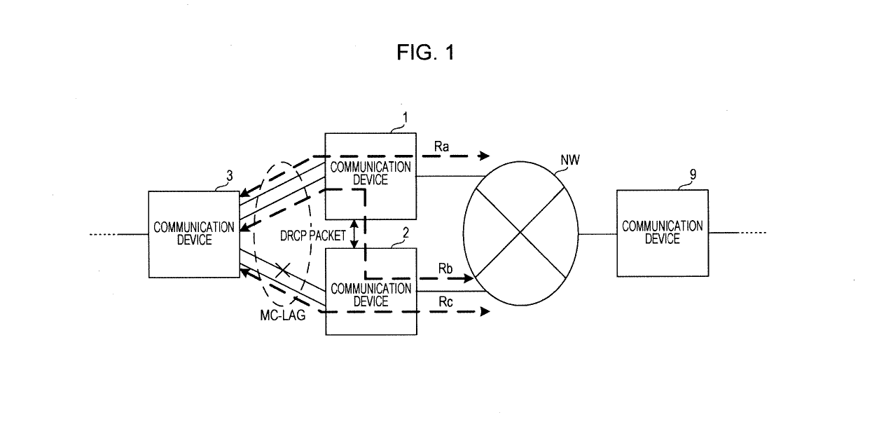

FIG. 1 is a configuration diagram illustrating an example of a network configuration. The network configuration includes communication devices 1 to 3, and 9, and a core network NW. The core network NW is an example of a network, and may be, for example, a local area network (LAN).

The communication device 3 is an example of a certain communication device, and is, for example a device that terminates a line on the side of a subscriber of communication service. The communication device 3 is coupled to the communication devices 1 and 2 through transmission paths such as optical fibers.

The communication devices 1 and 2 are respectively examples of a first communication device and a second communication device, and are, for example, routers. The communication devices 1 and 2 are coupled to the communication device 3 on the downstream side through a plurality of ports and coupled to the core network NW on the upstream side. As a result, each of the communication devices 1 and 2 relays the communication between the communication device 3 and the core network NW. The communication device 3 communicates with the network NW through a communication path Ra that passes through the communication device 1, and communicates with the network NW through a communication path Rc that passes through the communication device 2. The core network NW is coupled to a further network through the communication device 9.

Each of the communication devices 1 and 2 is set so as to achieve MC-LAG with the communication device 3. The communication devices 1 and 2 are treated as a single device when viewed from the communication device 3 by performing transmission and reception of DRCP packets to and from each other.

In addition, redundant of the communication devices 1 and 2 is achieved, and when a failure occurs in a line between the communication device 3 and one of the communication devices 1 and 2, relay of the communication is continued through a line between the communication device 3 and the other communication device. For example, when a failure occurs in a line (that is, a link) between the communication devices 3 and 2 (see x mark), the communication device 1 continues relay processing of the communication device 2 by communicating with the network NW through the communication device 2.

Therefore, the communication device 3 communicates with the network NW through a communication path Rb that passes through the communication devices 1 and 2, instead of the communication path Rc in which a failure has occurred. That is, when a failure occurs in the line between the communication devices 3 and 2, the relay path of the communication device 2 is switched from the active communication path Rc to the standby communication path Rb.

When a failure in the line between the communication devices 3 and 2 has been detected, the communication device 3 suspends transmission of a packet to the communication device 2, and transmits a packet destined to the communication device 2, to the communication device 1. When the communication device 1 receives the packet destined to the communication device 2, the communication device 1 transfers the packet to the communication device 2 depending on the destination.

In addition, in the case in which a failure in the line between the communication devices 3 and 2 has been detected, when the communication device 2 receives a packet destined to the communication device 3 from the network NW, the communication device 2 transfers the packet to the communication device 1 depending on the destination. As a result, the communication device 3 communicates with the network NW through the communication path Rc. As an example of a packet, there is an Ethernet (trademark) frame, but the embodiment is not limited to such an example, and for example, an internet protocol (IP) packet may be used. In addition, a packet is an example of a signal.

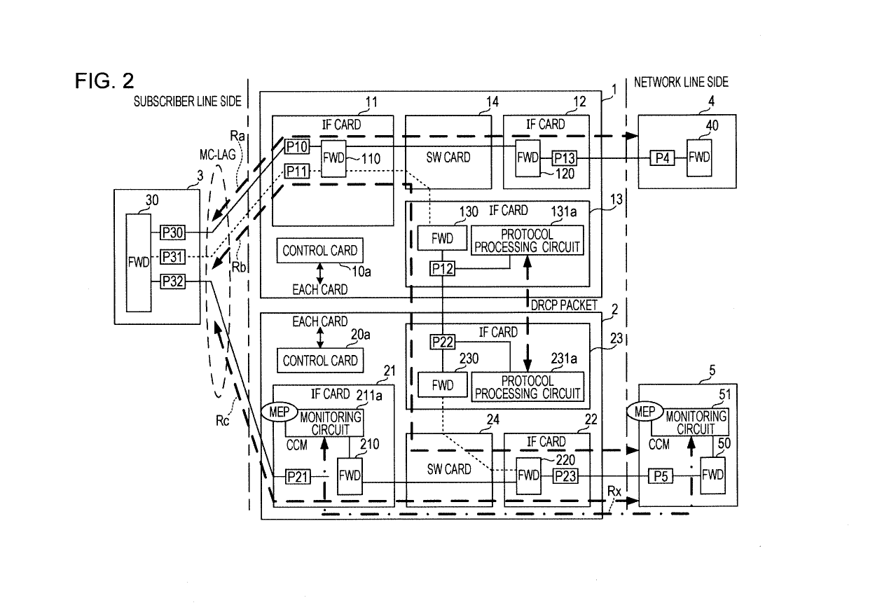

FIG. 2 is a configuration diagram illustrating a communication system in a comparative example. The communication system includes communication devices 1 to 5. The communication devices 1 to 3 correspond to the devices described above with reference to FIG. 1, and the communication devices 4 and 5 are device in the core network NW of FIG. 1, and each corresponds to, for example, a layer 2 switch.

In the communication system in this example, the communication device 3 is provided on the side of a subscriber line when viewed from the communication devices 1 and 2, and the communication devices 4 and 5 are provided on the side of a network line viewed from the communication devices 1 and 2. In addition, in FIG. 2, in the standby communication path Rb, a portion not used before switching of the communication path before a failure occur is indicated by a dotted line.

The communication device 1 includes interface (IF) cards 11 to 13, a switch (SW) card 14, a control card 10a. In addition, the communication device 2 includes IF cards 21 to 23, a SW card 24, and a control card 20a.

The IF cards 11 to 13 and 21 to 23, the SW cards 14 and 24, and the control cards 10a and 20a are, for example, circuit boards on each of which an electronic component is installed, and each of which is inserted into an individual slot provided on the front surface of a housing of each of the communication devices 1 and 2. The IF cards 11 to 13, the SW card 14, and the control card 10a communicate with each other through a wiring substrate provided on the back surface of the communication device 1, and the IF cards 21 to 23, the SW card 24, and the control card 20a communicate with each other through a wiring substrate provided on the back surface of the communication device 2.

In the communication device 1, the IF card 11 executes termination processing of a line between the communication devices 3 and 1, and the IF card 12 executes termination processing of a line between the communication devices 4 and 1. In addition, the IF card 13 executes termination processing of a line between the communication device 1 and the IF card 23 of the communication device 2. The SW card 14 exchanges packets between the IF cards 11 to 13. That is, the SW card 14 outputs a packet input from one of the IF cards 11 to 13, to a corresponding IF card depending on the destination. In addition, the control card 10a performs various types of control, setting, and alarm detection, for the IF cards 11 to 13 and the SW card 14.

In addition, in the communication device 2, the IF card 21 executes termination processing of a line between the communication devices 3 and 2, and the IF card 22 executes termination processing of a line between the communication devices 5 and 2. In addition, the IF card 23 executes termination processing of a line between the communication device 2 and the IF card 13 of the communication device 1. The SW card 24 exchanges packets between the IF cards 21 to 23. That is, the SW card 24 outputs a packet input from one of the IF cards 21 to 23, to a corresponding IF card depending on the destination. In addition, the control card 20a performs various types of control, setting, and alarm detection, for the IF cards 21 to 23 and the SW card 24.

The IF cards 11 and 21 are coupled to the communication device 3. The communication device 3 includes a transfer circuit (FWD) 30 and ports P30 to P32. The transfer circuit 30 transfers packets received from the network on the downstream side to the ports P30 to P32, and transfers packets input from the ports P30 to P32 to the network on the downstream side.

Each of the ports P30 to P32 includes, for example, an optical transmitter using a laser diode (LD) or the like, an optical receiver using a photodetector (PD) or the like, a physical layer (PHY)/media access control (MAC) device, or the like, and executes transmission processing and reception processing of packets. Further ports P11 to 13, P21 to 23, P4, and P5 described below have configurations similar to those of the ports P30 to P32.

The ports P30 and P31 are respectively coupled to ports P10 and P11 of the communication device 1 through transmission paths, and each performs transmission and reception of packets. A link between the port P30 and the port P10 is a part of a communication path Ra, and a link between the port P31 and the port P11 is a part of a communication path Rb.

The port P32 is coupled to the port P21 of the communication device 2 through a transmission path, and performs transmission and reception of packets. A link between the port P32 and the port P21 is a part of a communication path Rc.

The transfer circuit 30 transfers a packet destined to the communication device 4, to the port P30, and transfers a packet destined to the communication device 5, to the port P32. As a result, the communication device 3 communicates with the communication device 4 through the communication device 1 along the communication path Ra, and communicates with the communication device 5 through the communication device 2 along the communication path Rc.

In addition, when a failure has occurred in the line between the communication devices 3 and 2, a link between the port P32 and the port P21 is cut off. Therefore, when a failure has occurred in the line with the communication devices 3 and 2, the transfer circuit 30 transfers the packet destined to the communication device 5, to the port P31. As a result, the communication device 3 communicates with the communication device 5 through the communication device 1 along the communication path Rb.

The IF card 11 includes a transfer circuit (FWD) 110 and the ports P10 and P11. The transfer circuit 110 transfers a packet that has been input from the SW card 14, to one of the ports P10 and P11 corresponding to the transmission source, and transfers a packet that has been input from one of the ports P10 and P11, to the SW card 14. More specifically, the transfer circuit 110 outputs a packet received from the communication device 4, to the port P10, and outputs a packet received from the communication device 5, to the port P11. As a result, the packet received from the communication device 4 is transmitted to the communication device 3 along the communication path Ra, and the packet received from the communication device 5 is transmitted to the communication device 3 along the communication path Rb.

The IF card 12 includes a transfer circuit (FWD) 120 and a port P13. The transfer circuit 120 transfers a packet that has been input from the SW card 14, to the port P13 and transfers a packet that has been input from the port P13, to the SW card 14. The port P13 is coupled to the communication device 4 in the core network NW through a transmission path.

The communication device 4 includes a transfer circuit (FWD) 40 and a port P4. The transfer circuit 40 transfers a packet that has been received from a further communication device in the core network NW, to the port P4, and transfers a packet that has been input from the port P4, to the further communication device in the core network NW. The port P4 is coupled to the port P13 in the IF card 12 and performs transmission and reception of packet.

The IF card 13 includes a transfer circuit (FWD) 130, a port P12, and a protocol processing circuit 131a. The transfer circuit 130 transfers a packet that has been input from the SW card 14, to the port P12 and transfers a packet that has been input from the port P12, to the SW card 14. The port P12 is coupled to the communication device 2 through a transmission path, and performs transmission and reception of packets. The protocol processing circuit 131a is coupled to the port P12, and transmits and receives a DRCP packet to and from the IF card 23 of the communication device 2 through the port P12. The port P12 is coupled to a port P22 of the communication device 2 and performs transmission and reception of packets.

The control card 10a performs path setting on the SW card 14. To the SW card 14, a path that connects the transfer circuit 110 of the IF card 11 and the transfer circuit 120 of the IF card 12 (see, the solid line) and a path that connects the transfer circuit 110 of the IF card 11 and the transfer circuit 130 of the IF card 13 (see, the dotted line) are set. The path that connects the transfer circuit 110 of the IF card 11 and the transfer circuit 120 of the IF card 12 is a part of the communication path Ra, and the path that connects the transfer circuit 110 of the IF card 11 and the transfer circuit 130 of the IF card 13 is a part of the communication path Rb.

The SW card 14 outputs a packet that has been input from one of the transfer circuit 120 of the IF card 12 and the transfer circuit 130 of the IF card 13 and is destined to the communication device 3, to the transfer circuit 110 of the IF card 11. In addition, the SW card 14 outputs a packet that has been input from the transfer circuit 110 of the IF card 11 and is destined to the communication device 4, to the transfer circuit 120 of the IF card 12, and outputs a packet that has been from the transfer circuit 110 of the IF card 11 and is destined to the communication device 5, to the transfer circuit 130 of the IF card 13.

The IF card 23 includes a transfer circuit (FWD) 230, the port P22, and a protocol processing circuit 231a. The transfer circuit 230 transfers a packet that has been input from the SW card 24, to the port P22, and transfers a packet that has been input from the port P22, to the SW card 24. The port P22 is coupled to the port P12 of the communication device 1 through the transmission path, and transmits and receives packets to and from the communication device 1. The protocol processing circuit 231a is coupled to the port P22, and transmits and receives DRCP packets to and from the protocol processing circuit 131a of the communication device 1 through the port P22.

The IF card 21 includes a transfer circuit (FWD) 210, a monitoring circuit 211a, and the port P21. To the monitoring circuit 211a, a MEP is set through the control card 20a. The monitoring circuit 211a monitors the state of a communication path between the IF card 21 and the communication device 5 by transmitting and receiving CCMs to and from a MEP in the communication device 5 in the core network NW through the transfer circuit 210. The monitoring circuit 211a receives a CCM from the MEP in the communication device 5, and transmits a CCM to the MEP in the communication device as a response packet for the received CCM. The CCM received at the monitoring circuit 211a is an example of a monitoring packet used to monitor the communication path on the side of the network line. In addition, hereinafter, a CCM is described so as to be distinguished from a regular packet.

The transfer circuit 210 transfers a CCM that has been input from the SW card 24, to the monitoring circuit 211a, and transfers a packet that has been input from the SW card 24 and is destined to the communication device 3, to the port P21. In addition, the transfer circuit 210 transfers a packet that has been input from the port P21 and a CCM that has been input from the monitoring circuit 211a, to the SW card 24.

The IF card 22 includes a transfer circuit (FWD) 220 and a port P23. The transfer circuit 220 transfers a packet that has been input from the SW card 24, to the port P23, and transfers a packet that has been input from the port P23, to the SW card 24. The port P23 is coupled to the communication device 5 in the core network NW through a transmission path.

The communication device 5 includes a transfer circuit (FWD) 50, a monitoring circuit 51, and a port P5. To the monitoring circuit 51, the MEP is set. The monitoring circuit 51 monitors the state of the communication path between the IF card 21 and the communication device 5 by transmitting and receiving CCMs to and from the MEP of the monitoring circuit 211a in the IF card 21 through the transfer circuit 50.

More specifically, each of the monitoring circuits 51 and 211a performs transmission and reception of CCMs along a path Rx that passes through the SW card 24 and the IF card 22. For example, when each of the monitoring circuits 51 and 211a does not receive a CCM within a certain interval, the monitoring circuit detects LOC as an alarm, and when each of the monitoring circuits 51 and 211a has received a CCM within the certain interval, the monitoring circuit transmits a CCM as a response for the received CCM. Therefore, the communication device 2 may monitor the state of the communication path Rc on the side of the network line.

The transfer circuit 50 outputs, to the port P5, a packet that has been received from the further communication device in the core network NW and a CCM that has been input from the monitoring circuit 51. The transfer circuit 50 transfers a packet that has been input from the port P5, to the further communication device in the core network NW, and transfers a CCM that has been input from the port P5, to the monitoring circuit 51. The port P5 is coupled to the port P23 in the IF card 22 and performs transmission and reception of packets.

The control card 20a performs path setting on the SW card 24. To the SW card 24, a path that connects the transfer circuit 210 of the IF card 21 and the transfer circuit 220 of the IF card 22 (see, the solid line) and a path that connects the transfer circuit 230 of the IF card 23 and the transfer circuit 220 of the IF card 22 (see, the dotted line) are set by the control card 20a. The path that connects the transfer circuit 210 of the IF card 21 and the transfer circuit 220 of the IF card 22 is a part of the communication path Rc, and the path that connects the transfer circuit 230 of the IF card 23 and the transfer circuit 220 of the IF card 22 is a part of the communication path Rb.

The SW card 24 outputs a CCM and a packet that have been input from the transfer circuit 210 of the IF card 21 and the transfer circuit 230 of the IF card 23 and are destined to the communication device 5, to the transfer circuit 220 of the IF card 22. In addition, the SW card 24 switches the output destination of a CCM and a packet that have been input from the transfer circuit 220 of the IF card 22 depending on the presence or absence of a failure in the line between the communication devices 3 and 2.

The SW card 24 outputs a CCM and a packet that have been input from the transfer circuit 220 of the IF card 22 and is destined to the communication device 3, to the transfer circuit 210 of the IF card 21 when a failure does not occur in the line, and outputs the CCM and the packet to the transfer circuit 130 of the IF card 13 when a failure has occurred in the line.

As described above, when a failure does not occur in the line, the transfer circuit 220 and the SW card 24 receive a packet from the communication device 5 in the core network NW and transfer the packet to the communication device 3. The transfer circuits 210, 220, and 230, and the SW card 24 are examples of a second transfer processing circuit.

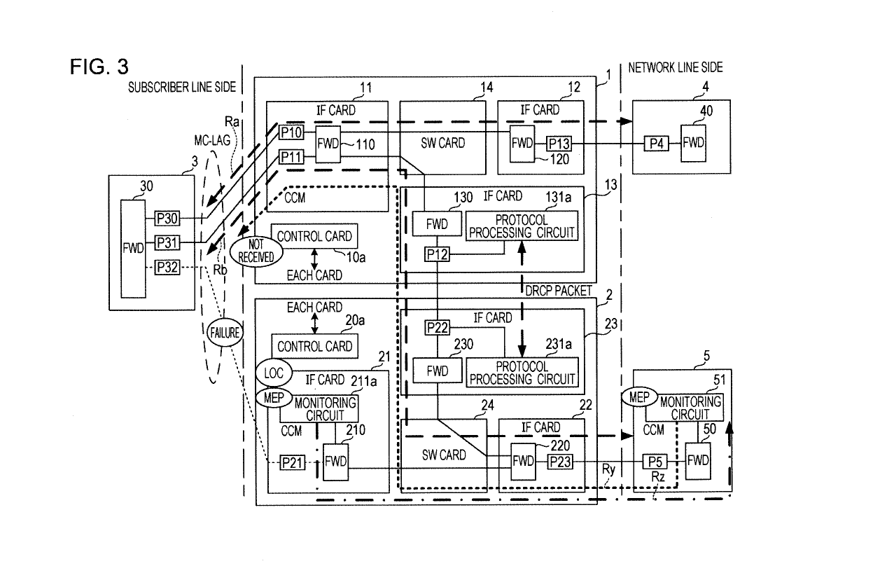

FIG. 3 is a diagram illustrating a switching operation of a communication path of the communication system in the comparative example. In FIG. 3, the same symbol is assigned to a configuration common with that of FIG. 2, and the description is omitted herein.

When a failure has occurred in the line between the communication devices 3 and 2 (see “failure”), the control card 20a detects the failure, for example, through link down notification received from the port P21 of the IF card 21. When the control card 20a has detected the failure in the line, the control card 20a switches the path setting of the SW card 24. As a result, in the SW card 24, the output destination of a packet and a CCM that have been transmitted from the communication device 5 is changed from the IF card 21 to the IF card 23.

Thus, the SW card 24 outputs a packet and a CCM that have been input from the transfer circuit 220 of the IF card 22, to the transfer circuit 230 of the IF card 23. Thus, a packet that has been transmitted from the communication device 5 and is destined to the communication device 3 arrives at the communication device 3 along the communication path Rb that passes through the communication devices 2 and 1 in order.

In addition, the transfer circuit 30 of the communication device 3 outputs a packet destined to the communication device 5, to the port P31. Therefore, the packet destined to the communication device 5 arrives at the communication device 5 along the communication path Rb that passes through the communication devices 1 and 2 in order.

As described above, in the communication device 2, when a failure occurs in the line between the communication devices 3 and 2, the transfer circuit 220 of the IF card 22, the transfer circuit 230 of the IF card 23, and the SW card 24 continue the relay processing by communicating with the communication device 3 through the communication device 1. That is, when a failure occurs in the line between the communication devices 3 and 2, the transfer circuits 220 and 230, and the SW card 24 transfer a packet to the communication device 3 through the communication device 1. Therefore, even when a failure occurs in the line between the communication devices 2 and 3, the communication device 3 may continue the communication with the core network NW through the communication device 2.

In addition, in the communication device 1, when a failure has occurred in the line between the communication devices 3 and 2, the transfer circuit 110 of the IF card 11, the transfer circuit 130 of the IF card 13, and the SW card 14 continue the relay processing of the communication device 2 by communicating with the core network NW 3 through the communication device 2 along the standby communication path Rb. That is, when a failure has occurred in the line between the communication devices 3 and 2, the transfer circuits 110 and 130, and the SW card 14 receive a packet from the communication device 5 in the core network NW through the communication device 2 and transfer the packet to the communication device 3.

Therefore, even when a failure occurs in the line between the communication devices 2 and 3, the communication device 3 may continue the communication with the core network NW through the communication device 2. The transfer circuits 110, 120, and 130, and the SW card 14 are examples of a first transfer processing circuit.

As described above, in the MC-LAG, when a failure has occurred in the line between the communication devices 3 and 2, the communication path is switched, but the MEP in the communication device 2 remains to be set on the communication path Rc before switching. Therefore, as described later, in the communication device 2, an alarm is detected by mistake due to non-reception of a CCM, and it is difficult to monitor the state of the communication path Rb after switching.

Even when a failure has occurred, a CCM that has been transmitted from the monitoring circuit 211a of the IF card 21 arrives at the monitoring circuit 51 of the communication device 5 because a path Rz in the SW card 24 is not changed. However, a CCM that has been transmitted from the monitoring circuit 51 of the communication device 5 is transmitted to the communication device 3 along a path Ry that passes through the IF card 13, the SW card 14, and the IF card 11 of the communication device 1 in order because of the above-described change in the path of the SW card 24. Therefore, the CCM is not received at the monitoring circuit 211a of the IF card 21 (see “not received”).

Thus, the monitoring circuit 211a detects LOC due to non-reception of a CCM from the monitoring circuit 51 of the communication device 5 (see “LOC”). Therefore, when the communication path has been switched due to the failure, it is difficult to monitor the state of the communication path Rb after switching.

Therefore, in an embodiment, when a failure has occurred in a line between communication devices 3 and 2, a communication device 1 monitors the state of a communication path by transmitting and receiving a CCM to and from a core network NW.

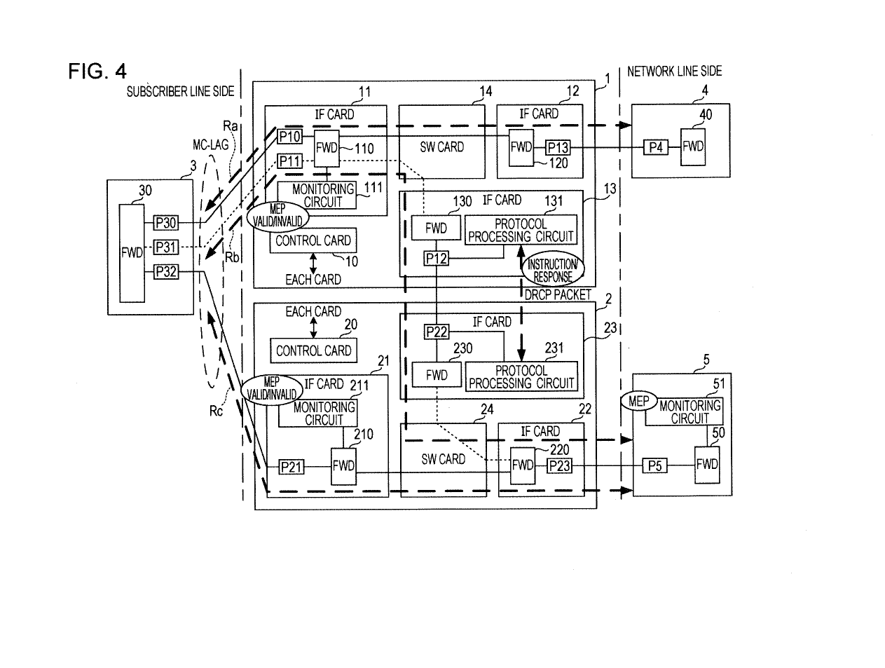

FIG. 4 is a configuration diagram illustrating a communication system according to the embodiment. In FIG. 4, the same symbol is assigned to a configuration common with that of FIG. 2, and the description is omitted herein.

The communication device 1 includes IF cards 11 to 13, a SW card 14, and a control card 10. In addition, the communication device 2 includes IF cards 21 to 23, a SW card 24, and a control card 20.

In the communication device 1 of this example, the control card 10 sets a MEP to the IF card 11 in advance. More specifically, a monitoring circuit 111 is provided in the IF card 11, and a MEP is set to the monitoring circuit 111.

The control card 10 may set the MEP of the monitoring circuit 111 valid or invalid. The control card 10 sets the MEP invalid when a failure does not occur in the line between the communication devices 3 and 2, and sets the MEP valid when a failure occurs in the line between the communication devices 3 and 2.

When the MEP is set valid, the monitoring circuit 111 starts transmission and reception of CCMs to and from the monitoring circuit 51 of the communication device 5 in the core network NW. At that time, in the communication device 2, a transfer circuit 220 of the IF card 22, a transfer circuit 230 of the IF cards 23, and the SW card 24 relay a CCM between the core network NW and the communication device 1.

Each of the monitoring circuits 111 and 51 performs transmission and reception of CCMs through the SW card 14 and the IF card 13 of the communication device 1, the SW card 24, and the IF cards 22 and 23 of the communication device 2. Therefore, the transmission and reception of the CCMs are performed along the standby communication path Rb that is a relay path of the IF cards 11 and 13 and the SW card 14.

As described above, when a failure has occurred in the line between the communication devices 3 and 2, the monitoring circuit 111 transmits and receives CCMs to and from the core network NW through the communication device 2 along the relay path of the IF cards 11 and 13 and the SW card 14. That is, when a failure has occurred in the line between the communication devices 2 and 3, the monitoring circuit 111 receives a CCM from the communication device 2 and transmits a CCM as a response packet for the received CCM, to the communication device 2. Therefore, the monitoring circuit 111 may monitor the state of the communication path Rb even when a failure has occurred. The monitoring circuit 111 is an example of a first transmission and reception circuit.

In addition, when a MEP has been set invalid, the monitoring circuit 111 stops to transmit and receive CCMs to and from the monitoring circuit 51. Therefore, when a failure does not occur in the line between the communication devices 3 and 2, the monitoring circuit 111 does not monitor the state of the communication path Rb.

In addition, the communication device 2 avoids erroneous detection of LOC by setting the MEP in the IF card 21 invalid. The IF card 21 includes a port P21, a transfer circuit 210, and a monitoring circuit 211.

The control card 20 may set a MEP of the monitoring circuit 211 valid or invalid. The control card 20 sets the MEP invalid when a failure does not occur in the between the communication devices 3 and 2, and sets the MEP valid when a failure occurs in the line between the communication devices 3 and 2.

When the MEP has been set valid, the monitoring circuit 211 starts to transmit and receives CCMs to and from the monitoring circuit 51 of the communication device 5 in the core network NW, similar to the monitoring circuit 211a in the comparative example. Each of the monitoring circuits 211 and 51 performs transmission and reception of CCMs through the SW card 24 and the IF card 22 of the communication device 2.

That is, when a failure does not occur in the line between the communication devices 2 and 3, the monitoring circuit 211 receives a CCM from the communication device 5 in the core network NW and transmits a CCM as a response packet for the received CCM, to the core network NW. Therefore, the CCMs are transmitted and received along the active communication path Rc that is a relay path of the SW card 24 and the IF card 22. Thus, when a failure does not occur, the monitoring circuit 211 may monitor the state of the communication path Rc.

In addition, when the MEP has been set invalid, the monitoring circuit 211 stops transmission and reception of CCMs. Therefore, the monitoring circuit 111 does not monitor the state of the communication path Rc when a failure does not occur in the line between the communication devices 3 and 2.

As described above, the monitoring circuit 211 transmits and receives CCMs to and from the core network NW before a failure occurs in the line between the communication devices 3 and 2, and stops transmission and reception of CCMs when a failure has occurred in the line. Therefore, when a failure has occurred, the monitoring circuit 211 may avoid erroneous detection of an alarm such as LOC. Thus, the monitoring circuit 111 of the communication device 1 may monitor the communication path, instead of the monitoring circuit 211. The monitoring circuit 211 is an example of a second transmission and reception circuit.

In addition, a protocol processing circuit 131 of the IF card 13 of the communication device 1 and a protocol processing circuit 231 of the IF card 23 of the communication device 2 perform transmission and reception of DRCP packets to and from each other through the ports P12 and 22 similar to the protocol processing circuits 131a and 231a in the comparative example. Each of the protocol processing circuits 131 and 231 performs transmission and reception of an instruction and a response by DRCP packets (see “instruction/response”). When the control card 20 has detected a failure in the line between the communication devices 3 and 2, the control card 20 outputs a switching instruction of a MEP, to the protocol processing circuit 231 of the IF card 23.

The protocol processing circuit 231 transmits the switching instruction of a MEP, to the protocol processing circuit 131 of the IF card 13 of the communication device 1 so as to cause the switching instruction of the MEP to be included in the DRCP packet. The protocol processing circuit 131 notifies the control card 10 of reception of the switching instruction of the MEP. The control card 10 sets the MEP of the monitoring circuit 111 valid in response to the reception notification. As a result, the monitoring circuit 111 starts transmission and reception of CCMs.

As described above, when a failure has occurred in the line with the communication devices 3 and 2, the protocol processing circuit 231 of the communication device 2 instructs the monitoring circuit 111 of the communication device 1 to start transmission and reception of CCMs. When a failure has occurred in the line, the monitoring circuit 111 starts transmission and reception of CCMs in response to the instruction received from the protocol processing circuit 231 of the communication device 2.

Thus, when a failure has occurred in the line with the communication devices 3 and 2, the communication device 2 may notify the monitoring circuit 111 of the communication device 1 of start timing of transmission and reception of CCMs. The protocol processing circuit 231 of the communication device 2 is an example of an instruction circuit.

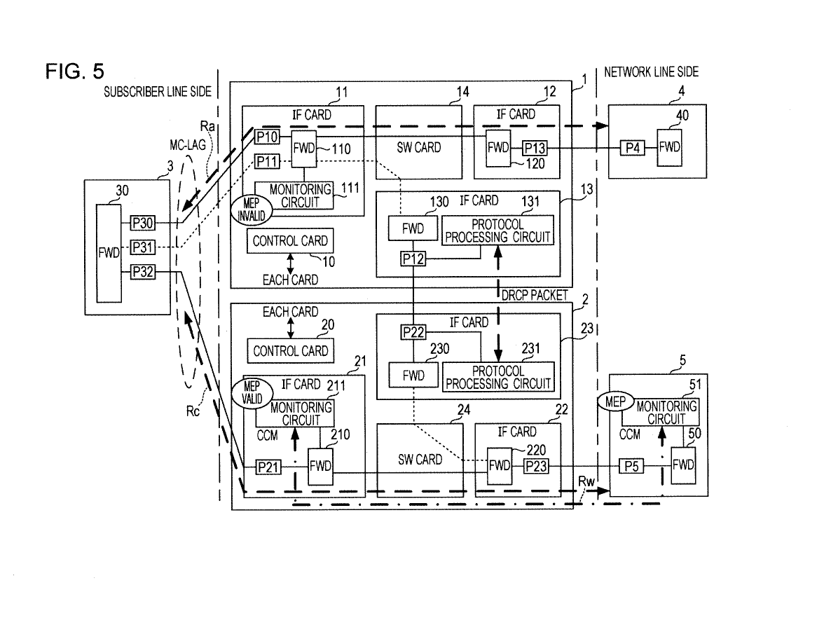

FIG. 5 is a diagram illustrating an operation before switching in a communication path of the communication system according to the embodiment. In FIG. 5, the same symbol is assigned to a configuration common with that of FIG. 4, and the description is omitted herein.

When a failure does not occur in the line with the communication devices 2 and 3, the communication device 3 communicates with the core network NW through the active communication path Rc. That is, the communication device 2 relays the communication between the communication devices 3 and 5 through the communication path Rc that passes through the IF cards 21 and 22 and the SW card 24.

In addition, the control card 20 of the communication device 2 sets the MEP of the monitoring circuit 211 valid when a failure does not occur in the line between the communication devices 3 and 2. Therefore, the monitoring circuit 211 transmits and receives CCMs to and from the monitoring circuit 51 of the communication device 5 through a path Rw that passes through the IF cards 21 and 22, and the SW card 24. That is, the monitoring circuit 211 performs transmission and reception of CCMs along the relay path for packets of the transfer circuit 210 of the IF card 21, the transfer circuit 220 of the IF card 22, and the SW card 24.

In addition, the control card 10 of the communication device 1 sets the MEP of the monitoring circuit 111 invalid when a failure does not occur in the line between the communication devices 2 and 3. Therefore, the monitoring circuit 111 stops transmission and reception of CCMs.

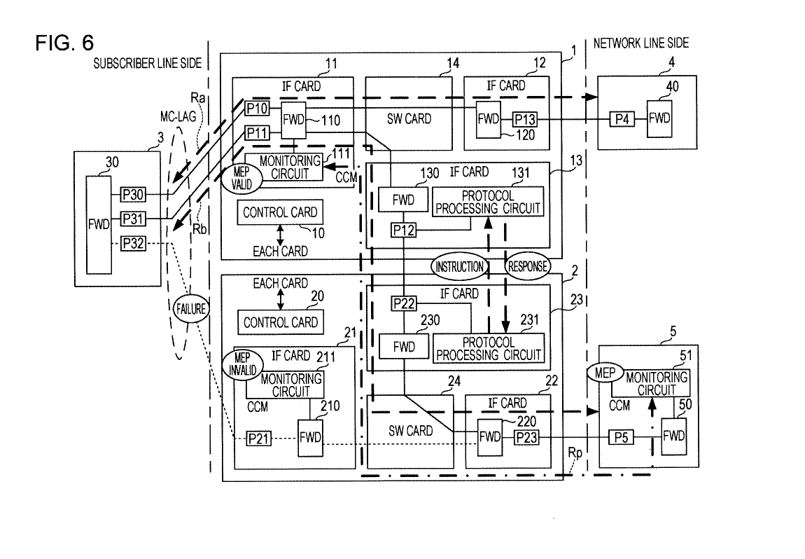

FIG. 6 is a diagram illustrating an operation after switching in the communication path of the communication system according to the embodiment. In FIG. 6, the same symbol is assigned to a configuration common with that of FIG. 4, and the description is omitted herein.

The control card 20 of the communication device 2 sets the MEP of the monitoring circuit 211 invalid when a failure has occurred in the line between the communication devices 3 and 2. Therefore, the monitoring circuit 211 stops transmission and reception of CCMs. Thus, detection of an alarm such as LOC is avoided.

In addition, when a failure has occurred in the line between the communication devices 3 and 2, the transfer circuit 220 of the IF card 22, the transfer circuit 230 of and the IF card 23, and the SW card 24 transmit a CCM received from the core network NW, to the communication device 1, receive a CCM as a response packet for the transmitted CCM, from the communication device 1, and transfer the CCM to the communication device 5 in the core network NW. Therefore, the monitoring circuit 111 may monitor the state of the communication path between the core network NW and the communication device 1, as described above.

In addition, the protocol processing circuit 231 of the communication device 2 transmits a switching instruction of a MEP, to the protocol processing circuit 131 of the communication device 1. The protocol processing circuit 131 notifies the control card 10 of reception of the instruction.

The control card 10 of the communication device 1 sets the MEP of the monitoring circuit 111 valid in response to the reception notification of the switching instruction of a MEP. Therefore, the monitoring circuit 111 transmits and receives CCMs to and from the monitoring circuit 51 of the communication device 5 through a path Rp that passes through the IF cards 11, 13, 21, and 22 and the SW cards 14 and 24. That is, the monitoring circuit 111 performs transmission and reception of CCMs along the relay path for packets of the transfer circuit 110 of the IF card 11, the transfer circuit 130 of the IF card 13, and the SW card 14.

After the control card 10 has set the MEP of the monitoring circuit 111 valid, the control card 10 instructs the protocol processing circuit 131 to perform completion notification of the switching of a MEP as a response for the switching instruction of a MEP. The protocol processing circuit 131 transmits a DRCP packet including the completion notification, to the protocol processing circuit 231 of the communication device 2. The protocol processing circuit 231 notifies the control card 20 of reception of the completion notification of the switching of a MEP.

When the failure in the line between the communication devices 2 and 3 has been recovered, the communication devices 1 and 2 may return the communication states to the state in FIG. 5. In this case, the protocol processing circuit 131 of the communication device 1 transmits a DRCP packet including an instruction of switch-back of a MEP, to the protocol processing circuit 231 of the communication device 2. As a result, the control card 20 of the communication device 2 performs a setting so as to return the MEP of the monitoring circuit 211 valid. In addition, the control card 10 of the communication device 1 returns the MEP of the monitoring circuit 111 invalid when a failure in the line has been detected.

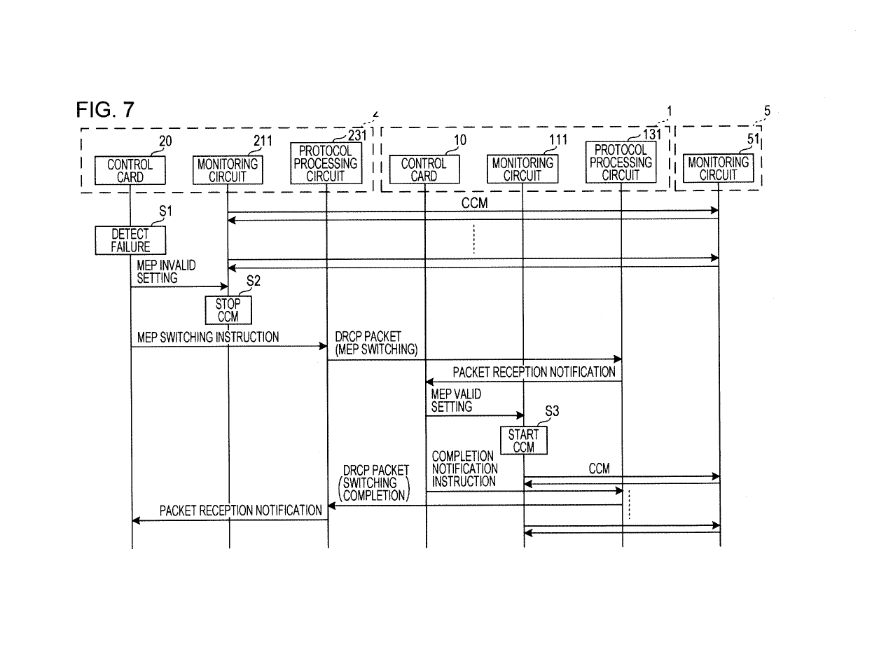

FIG. 7 is a sequence diagram illustrating an operation of the communication system according to the embodiment. Before a failure in the line between the communication devices 2 and 3 occurs, the monitoring circuit 211 of the communication device 2 transmits and receives CCMs to and from the monitoring circuit 51 of the communication device 5 because the MEP is set valid. Each of the monitoring circuits 51 and 211 detects LOC when the monitoring circuit does not receive a CCM in the certain time period after having transmitted a CCM.

When the control card 20 of the communication device 2 detects a failure in the line between the communication devices 2 and 3 (see the symbol S1), the control card 20 sets the MEP of the monitoring circuit 211 invalid. As a result, the monitoring circuit 211 stops transmission and reception of CCMs (see the symbol S2).

After that, the control card 20 outputs a switching instruction of a MEP to the protocol processing circuit 231. After that, the protocol processing circuit 231 transmits a DRCP packet including the switching instruction of a MEP, to the protocol processing circuit 131 of the communication device 1.

The protocol processing circuit 131 notifies the control card 10 of reception of the DRCP packet including the switching instruction of a MEP. When the control card 10 receives the reception notification, the control card 10 sets the MEP of the monitoring circuit 111 valid. As a result, the monitoring circuit 111 monitors transmission and reception of CCMs to and from the monitoring circuit 51 of the communication device 5 (see the symbol S3).

After that, the control card 10 instructs the protocol processing circuit 131 to perform completion notification of the switching of a MEP. The protocol processing circuit 131 transmits a DRCP packet including the completion notification of the switching of a MEP, to the protocol processing circuit 231 of the communication device 2. The protocol processing circuit 231 notifies the control card 20 of reception of the DRCP packet including the completion notification of the switching of a MEP. The communication system operates as described above.

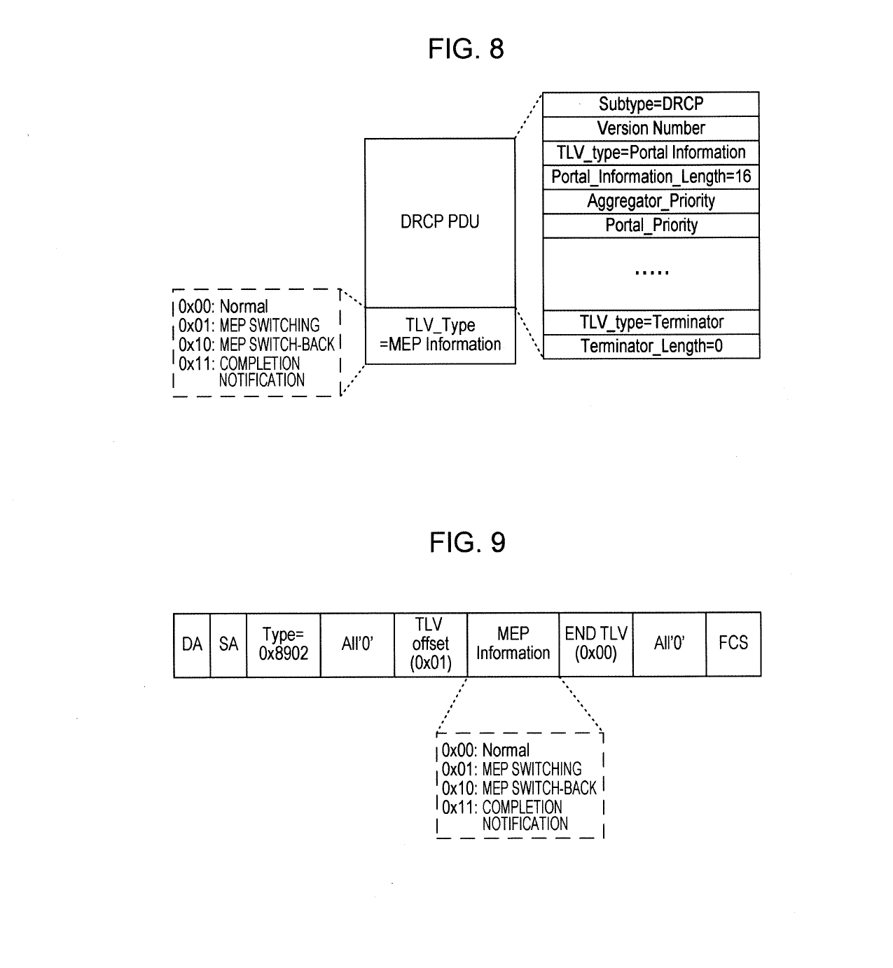

FIG. 8 is a configuration diagram illustrating an example of a DRCP packet. The DRCP packet is obtained by adding “MEP Information” as new type, length, and value (TLV) to “DRCP protocol data unit (PDU)” that has been defined in IEEE802.1ax. Here, “DRCP PDU” includes various pieces of control information such as “Subtype=DRCP” and “Version Number”.

Here, “MEP Information” includes control information of 1 (Byte) related to switching of a MEP. When each of the protocol processing circuits 131 and 231 does not use “MEP Information”, the protocol processing circuit sets “MEP Information” at the value of “0x00” (see “Normal”). In addition, “0x” represents a hexadecimal notation.

When the protocol processing circuit 231 of the communication device 2 transmits a DRCP packet including a switching instruction of a MEP, to the protocol processing circuit 131 of the communication device 1, the protocol processing circuit 231 sets “MEP Information” at the value of “0x01”. When the protocol processing circuit 131 of the communication device 1 transmits a DRCP packet including completion notification of the switching of a MEP, to the protocol processing circuit 231 of the communication device 2, the protocol processing circuit 131 sets “MEP Information” at the value of “0x11”. In addition, when the protocol processing circuit 131 of the communication device 1 transmits a DRCP packet including a switch-back instruction of a MEP, to the protocol processing circuit 231 of the communication device 2, the protocol processing circuit 131 sets “MEP Information” at the value of “0x10”.

Here, “MEP Information” is not limited to a DRCP packet, and may be included in a further packet. That is, each of the protocol processing circuits 131 and 231 is not limited to a DRCP, and may perform transmission and reception of “MEP Information” in accordance with a further protocol.

FIG. 9 is a configuration diagram illustrating a further example of a control packet related to switching of a MEP. The control packet includes a destination address (DA), a source address (SA), Type (=0x8902), “TLV Offset” (=0x1), “MEP Information”, “END TLV” (=0x00), and a frame check sequence (FCS).

Here, “DA” represents a MAC address of a transmission source of the control packet, and “SA” indicates a MAC address of a destination of the control packet. In addition, “Type” indicates the type of the control packet.

Here, “TLV Offset” and “END TLV” respectively indicate a starting point and an ending point of “MEP Information”. As an example, a content of “MEP Information” is defined similar to the case of the DRCP packet (see, the frame of the dotted line). In addition, “FCS” is a data error correction code of the control packet.

As an example, the control packet is generated as a packet having a 64 (Byte) length by padding of “0” value, but the embodiment is not limited to such an example.

In the communication system according to the embodiment, the MEP of the communication device 1 and the MEP of the communication device 2 are used so as to be switched depending on switching of a communication path, but the switching may be performed in a unit of a MEP instance group including a plurality of MEPs.

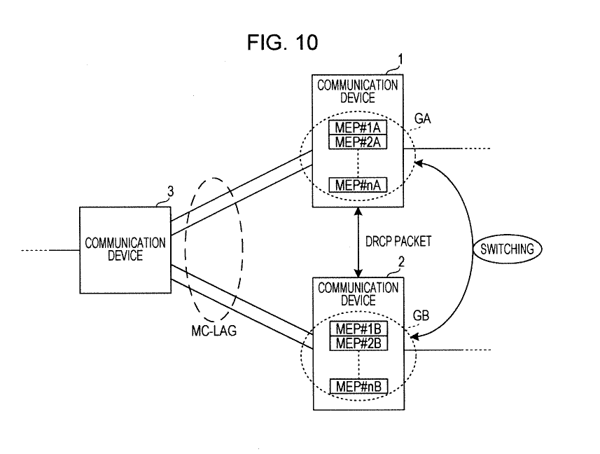

FIG. 10 is a diagram illustrating an example of a switching operation of a MEP instance group. In FIG. 10, the same symbol is assigned to a configuration common with that of FIG. 1, and the description is omitted herein.

To the communication device 1, a MEP instance group GA including a MEP #1A to a MEP #nA (n: positive integer) is set. In addition, to the communication device 2, a MEP instance group GB including a MEP #1B to a MEP #nB is set.

The communication system switches the used MEP instance groups GA and GB depending on switching of a communication path (see “switching”). As a result, the communication system may continue to monitor the state of a communication path by controlling the plurality of MEPs in bulk.

As described above, the communication device 1 according to the embodiment relays the communication between the certain communication device 3 and the core network NW. The communication device 1 includes the transfer circuits 110 and 130, the SW card 14, and the monitoring circuit 111.

When a failure has occurred in the line between the communication devices 2 and 3, the transfer circuits 110 and 130, and the SW card 14 receive a packet from the core network NW through the communication device 2 and transfers the packet to the communication device 3. In addition, when a failure has occurred in the line, the monitoring circuit 111 receives a CCM used to monitor the communication path between the communication device 2 and the core network NW, from the communication device 2, and transmits a CCM as a response packet for the received CCM, to the communication device 2.

In the above-described configuration, the transfer circuits 110 and 130, and the SW card 14 transfer a packet to the communication device 3 from the core network NW through the communication device 2, so that the communication device 3 may continue the communication with the core network NW even when a failure occurs in the line between the communication devices 2 and 3. In addition, the monitoring circuit 111 transmits and receives CCMs to and from the core network NW through the communication device 2, so that the monitoring circuit may monitor the state of the communication path Rb even when a failure has occurred in the line.

In addition, the communication device 2 according to the embodiment relays the communication between the certain communication device 3 and the core network NW. The communication device 2 includes the transfer circuits 210, 220, and 230, the SW card 24, and the monitoring circuit 211.

The transfer circuits 210 and 220, and the SW card 24 receive a packet from the core network NW and transfers the packet to the certain communication device 3. The transfer circuits 220 and 230 and the SW card 24 transfer a packet to the certain communication device 3 through the communication device 1 when a failure has occurred in the line between the communication devices 3 and 2.

In addition, the monitoring circuit 211 receives a CCM from the core network NW, and transmits a CCM as a response packet for the received CCM, to the core network NW. When a failure has occurred in the line between the communication devices 3 and 2, the transfer circuits 220 and 230, and the SW card 24 transmit a CCM received from the core network NW, to the communication device 1, receives a CCM as a response packet for the received CCMs from the communication device 1, and transfers the CCM to the core network NW. When a failure has occurred in the line between the communication devices 3 and 2, the monitoring circuit 211 stops transmission and reception of CCMs.

In the above-described configuration, the transfer circuits 220 and 230, and the SW card 24 transfer a packet to the certain communication device 3 through the communication device 1, so that the communication device 3 may continue the communication with the core network NW even when a failure occurs in the line between the communication devices 2 and 3.

In addition, the monitoring circuit 211 stops transmission and reception of CCMs when a failure has occurred in the line between the communication devices 3 and 2. Therefore, when a failure has occurred in the line, the monitoring circuit 211 may avoid erroneous detection of an alarm such as LOC. Thus, the monitoring circuit 111 of the communication device 1 may monitor the communication path, instead of the monitoring circuit 211.

In addition, the communication system according to the embodiment includes the communication device 1 and the communication device 2 each of which relays the communication between the certain communication device 3 and the core network NW. The communication device 1 includes the transfer circuits 110 and 130, the SW card 14, and the monitoring circuit 111.

When a failure has occurred in the line between the communication devices 2 and 3, the transfer circuits 110 and 130, and the SW card 14 receive a packet from the core network NW through the communication device 2 and transfer the packet to the communication device 3. In addition, when a failure has occurred in the line, the monitoring circuit 111 receives a CCM used to monitor the communication path between the communication device 2 and the core network NW, from the communication device 2, and transmits a CCM as a response packet for the received CCM, to the communication device 2.

The communication device 2 relays the communication between the certain communication device 3 and the core network NW. The communication device 2 includes the transfer circuits 210, 220, and 230, the SW card 24, and the monitoring circuit 211.

In addition, the communication device 2 relays the communication between the certain communication device 3 and the core network NW with the communication device 1. The communication device 2 includes the transfer circuits 220 and 230, the SW card 24, and the monitoring circuit 211.

The transfer circuits 210 and 220 and the SW card 24 receive a packet from the core network NW and transfers the packet to the certain communication device 3. The transfer circuits 220 and 230 and the SW card 24 transfer a packet to the certain communication device 3 through the communication device 1 when a failure has occurred in the line between the communication devices 3 and 2.

In addition, the monitoring circuit 211 receives a CCM from the core network NW and transmits a CCM as a response packet for the received CCM, to the core network NW. When a failure has occurred in the line between the communication devices 3 and 2, the transfer circuits 220 and 230, and the SW card 24 transmit a CCM received from the core network NW, to the communication device 1, receives a CCM as a response packet for the transmitted CCM, from the communication device 1, and transfers the CCM to the core network NW. The monitoring circuit 211 stops transmission and reception of CCMs when a failure has occurred in the line between the communication devices 3 and 2.

The communication system according to the embodiment includes a configuration similar to those of the communication devices 1 and 2 according to the embodiment, so that an operation effect similar to the above-described content is achieved.

Each of the above-described transfer circuits, monitoring circuits, transfer processing circuits, protocol processing circuits, transmission and reception circuits from which reference symbols are removed may be configured, for example, by a single element or a combination of two or more elements from among a central processing unit (CPU), a micro processing unit (MPU), a digital signal processor (DSP), an integrated circuit (IC), and a programmable logic device (PLD). The above-described embodiments are preferred examples of the technology discussed herein. However, the embodiments are not limited to such examples, and various modifications can be implemented within a range not departing from the gist of the technology discussed herein.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device that relays a communication between a certain communication device and a network, the communication device comprising:
a transfer processing circuit configured to receive a signal from the network through a further communication device and transfer the signal to the certain communication device when a failure occurs in a line between the further communication device and the certain communication device; and
a transmission and reception circuit configured to receive, from the further communication device, a monitoring packet used to monitor a communication path between the further communication device and the network and transmit a response packet for the monitoring packet to the further communication device.

2. The communication device according to claim 1, wherein
the transmission and reception circuit is configured to start reception of the monitoring packet and transmission of the response packet in response to an instruction from the further communication device when the failure occurs in the line.

3. A communication device that relays a communication between a certain communication device and a network, the communication device comprising:
a transfer processing circuit configured to receive a signal from the network and transfers the signal to the certain communication device; and
a transmission and reception circuit configured to receive, from the network, a monitoring packet used to monitor a communication path between the network and the communication device and return a response packet for the monitoring packet to the network, wherein
the transfer processing circuit is configured to transfer the signal to the certain communication device through a further communication device, transmit the monitoring packet received from the network, to the further communication device, receive a response packet for the monitoring packet from the further communication device, and return the response packet to the network when a failure occurs in a line between the communication device and the certain communication device, and
the transmission and reception circuit is configured to stop reception of the monitoring packet and return of the response packet when the failure occurs in the line.

4. The communication device according to claim 3 further comprising:
an instruction circuit configured to instruct the further communication device to start reception of the monitoring packet and return of the response packet when the failure occurs in the line.

5. A communication system, comprising:
a first communication device configured to relay a communication between a certain communication device and a network; and
a second communication device configured to relay a communication between the certain communication device and the network, wherein
the first communication device includes
a first transfer processing circuit configured to receive a signal from the network through the second communication device and transfer the signal to the certain communication device when a failure occurs in a line between the second communication device and the certain communication device, and
a first transmission and reception circuit configured to receive, from the second communication device, a monitoring packet used to monitor a communication path between the second communication device and the network and transmit a response packet for the monitoring packet to the second communication device when the failure occurs in the line, and
the second communication device includes
a second transfer processing circuit configured to receive the signal from the network and transfer the signal to the certain communication device, and
a second transmission and reception circuit configured to receive the monitoring packet from the network and return the response packet for the monitoring packet to the network, wherein
the second transfer processing circuit is configured to transfer the signal to the certain communication device through the first communication device, transmit the monitoring packet received from the network to the first communication device, receive the response packet from the first communication device, and return the response packet to the network when the failure occurs in the line, and
the second transmission and reception circuit is configured to stop reception of the monitoring packet and transmission of the response packet when the failure occurs in the line.

6. The communication system according to claim 5, wherein
the second communication device further includes an instruction circuit that is configured to instruct the first communication device to start reception of the monitoring packet and return of the response packet when the failure occurs in the line, and
the first transmission and reception circuit is configured to start reception of the monitoring packet and return of the response packet in response to the instruction from the instruction circuit.
